(19) United States
(12) Patent Application Publication
(10) Pub. No.: US 2017/0363059 A1
(43) Pub. Date: Dec. 21, 2017

(54) HYDRAULIC ENGINE WITH HYDRAULIC PUMP

(71) Applicant: Shin Chong PYO, Incheon-city (KR)

(72) Inventor: Shin Chong PYO, Incheon-city (KR)

(21) Appl. No.: 15/612,387

(22) Filed: Jun. 2, 2017

(30) Foreign Application Priority Data
Jun. 20, 2016 (KR) 10-2016-0076554

(51) Int. Cl. F03C 1/06

(52) U.S. Cl. CPC F03C 1/061; F03C 1/0607; F03C 1/0628

(57) ABSTRACT

A hydraulic engine with hydraulic pumps that moves the oil filled in the body thereof through the hydraulic pumps to allow rotational load bodies to be driven by means of the reciprocation of pistons, thereby obtaining a rotational force required for driving, includes: a power supply adapted to supply power to a driving part and to charge the power generated from rotational load bodies through the driving of a power driving part; the driving part driven through the power supplied from the power supply; a pair of hydraulic pumps adapted to pump a fluid through the rotation of the driving part; and the power driving part adapted to generate a driving force through the reciprocation of a driving piston.

### CROSS REFERENCE

This application claims foreign priority under Paris Convention to Korean Patent Application No. 10-2016-0076554, filed 20 Jun. 2016, with the Korean Intellectual Property Office.

The present invention relates to a hydraulic engine with hydraulic pumps, and more particularly, to a hydraulic engine with hydraulic pumps that moves the oil filled in the body thereof through the hydraulic pumps to allow rotational load bodies to be driven by means of the reciprocation of pistons, thereby obtaining a rotational force required for driving.

### BACKGROUND

Generally, a conventional heat engine is an engine which applies a thermal energy generated from the combustion of fuel as a heat source to a working fluid, expands the working fluid, converts the mechanical energy generated from the expansion of the working fluid into a shaft torque or fluid blowing, and thus obtains power therefrom.

Since heat is applied at a low temperature to the working fluid having a small volume to make the high temperature working fluid, a temperature difference in the heat engine is important, without exception, and therefore, the higher the temperature difference is, the higher the expansion force of the working fluid is.

The heat engine is largely divided into an external combustion engine and an internal combustion engine according to the kinds of working fluids, the expansion processes of the working fluids, the main mechanisms of the engine, and the states of the power generated therefrom.

The external combustion engine basically burns the fuel through a boiler located at the outside of the engine body, applies the heat generated from the fuel to the water stored in the boiler to make steam, induces the superheated steam as the working fluid having an expansion pressure to the engine body, and converts the superheated steam into successive power.

A steam engine as one of the external combustion engines is classified into a positive displacement piston type steam engine that applies the expansion pressure of the working fluid to a piston and converts the reciprocation of the piston into the torque of crankshafts and a velocity turbine type steam engine that applies the pressure of the working fluid to a turbine and generates a torque from the shaft of the turbine.

The steam engine may use low quality fuel like coals or heavy oil, and if the expansion pressure of the steam is maintained constantly, the rotational speed region of the shaft becomes large so that advantageously, there is no need to install a transmission, the torque is constant irrespective of the degree of the rotational speed of the shaft, the engine itself starts to rotate, and a degree of exhaust gas contamination due to external combustion is reduced.

Contrarily, the steam engine has the following problems. That is, there is a need to install the boiler having large volume and weight on the outside, a large radiator has to be installed to pluralize the steam, a substantially long period of time is delayed until water is turned into the superheated steam before the engine works, rapid heating of water is delayed when the acceleration in heating the water is needed, working and stopping are repeatedly carried out, the steam engine is not adequate for the external combustion engine for automobiles that have to has large power ranges, and above all, the heat efficiency of the energy is greatly decreased according to the changes in the internal energy of water when the water is vaporized.

The internal combustion engine is the heat engine which carries out the combustion of fuel and the expansion of a working fluid in the interior thereof at the same time, and accordingly, the internal combustion engine has the following advantages. That is, there is no need to install any combustion device like a boiler, the engine is small and lightness, the engine starts in a short time through a small-sized starting device, the engine is made in a wide range from a small output to a large output, and the acceleration of the output is rapidly adjusted, so that the internal combustion engine is adequate for the engine for automobiles. However, the internal combustion engine has the following disadvantages. That is, the heat efficiency is decreased, there is a need to install a cooling device due to the high temperature of the engine, the lowest rotational range of the engine is determined, a transmission has to be mounted on the output of the engine, fuel is unnecessarily consumed due to the continuous working of the engine upon the brake of the engine of a vehicle, good quality fuel is needed, and above all, air pollution is seriously caused by exhaust gas.

Further, most of heat engine automobiles have the following problems. That is, the rotation output of the engine is cooperatively operated with the load side, so that the spare energy generated from the engine cannot be stored, thereby making it difficult to reuse the energy generated from the engine brake of the automobile, and the rotation output of the engine cannot be reversed, thereby requiring a separate reversing gear. Furthermore, it is necessary to install successive crank mechanisms and all kinds of power transmission belts according to the linear reciprocation of the piston of the engine, thereby making the engine very complicated in configuration, and also, there is a need to install a differential gear on an output load side of the rear end of the transmission of the automobile engine.

One example of conventional hydraulic engines is disclosed in Korean Patent Application No. 10-2000-0036673 (dated on Jul. 5, 2000 and entitled ‘hydraulic engine vehicle’), which is hereinafter referred to as ‘Patent Document 1’.

According to Patent Document 1, the hydraulic engine vehicle, which is in the fields of heat engine and driving system, is configured wherein air is compressed by means of a compressor operated with hydraulic energy and is burnt in a combustor together with fuel so that the hydraulic energy is increasingly produced through the increment of the operating force of an expander with the volume expansion of the compressed burnt gas, and a hydraulic motor is driven with the increased hydraulic energy. In this case, the hydraulic engine vehicle includes the piston type compressor that is continuously reciprocated by the hydraulic energy through the control of a pilot-operated control valve and a pilot-operated normally open and closed type opening and closing valve operated with the hydraulic energy and produces the compressed air.

Further, the hydraulic engine vehicle includes the combustor capable of adjusting the flow rate of fuel in the successive combustion of the compressed air together with the fuel, the piston type expander continuously reciprocated by the compressed burnt gas through the control of a pilot-operated control valve and a pilot-operated normally open and closed type opening and closing valve operated with the hydraulic energy to produce the compressed air, an exhaust turbine rotating by means of the exhaust heat and exhaust pressure of the exhaust gas of the expander, a cooling tank in which cooling water is stored to allow the compressor and the expander to be submergedly disposed therein so that cooling water is heated with the air compressed heat and a cooling heat source of the expander to produce steam energy, and a steam turbine rotating with the steam energy heated to a high temperature through the exhaust gas heat source of the exhaust turbine.

Furthermore, the hydraulic engine vehicle includes a hydraulic pump and a generator cooperatively operated with the rotational shafts of the exhaust turbine and the steam turbine to produce the hydraulic energy and the electric energy, a reversing hydraulic motor having two independent driving shafts having driving load forces obtained by the hydraulic energy and the same torque characteristics as each other, and an intensifier for intensifying the hydraulic energy to a plurality of stages to store the intensified energy to an accumulator or to drive the hydraulic motor.

Another example of conventional hydraulic engines is disclosed in Korean Patent Application No. 10-2005-0092218 (dated on Sep. 21, 2005 and entitled ‘electric hydraulic engine’), which is hereinafter referred to as ‘Patent Document 2’.

According to Patent Document 2, the electric hydraulic engine includes a battery to which power is charged, a power supply and charging controller for supplying the power of the battery to an electric motor and for controlling the power generated from a generator so that the power is charged to the battery or supplied as the driving power of the electric motor, the electric motor driven by means of the power of the battery or the power generated from the generator under the control of the power supply and charging controller to produce a rotational force, a hydraulic pump for pumping the oil accommodated in an oil tank with the rotational force of the electric motor to produce hydraulic pressure used as the driving sources of first and second hydraulic motors, the first hydraulic motor driven by means of the hydraulic pressure produced from the hydraulic pump to produce a rotational force that is usable as a main power source, the second hydraulic motor driven by means of the hydraulic pressure produced from the hydraulic pump to produce a rotational force for power generation, and the generator for generating power by means of the rotational force of the second hydraulic motor to supply the generated power as the charging power of the battery or the driving power of the electric motor under the control of the power supply and charging controller.

Advantageously, the conventional hydraulic engine vehicle can drive the vehicle with the hydraulic pressure, and disadvantageously, it is limitedly installed in the vehicle. Further, the conventional electric hydraulic engine inconveniently has to cool the heat generated by the rotation of the hydraulic motors.

### SUMMARY OF THE INVENTION

Accordingly, the present invention has been made in view of the above-mentioned problems occurring in the prior art, and it is an object of the present invention to provide a hydraulic engine with hydraulic pumps that has a plurality of rotational load bodies on a single power driving part in such a manner as to be at the same time driven by means of the rotational force generated from the power driving part.

It is another object of the present invention to provide a hydraulic engine with hydraulic pumps that is capable of driving an engine or generator with the rotational force generated from a power driving part.

To accomplish the above-mentioned objects, according to the present invention, there is provided a hydraulic engine including: a power supply adapted to supply power to a driving part and to charge the power generated from rotational load bodies through the driving of a power driving part; the driving part driven through the power supplied from the power supply; a pair of hydraulic pumps adapted to pump a fluid through the rotation of the driving part; and the power driving part adapted to generate a driving force through the reciprocation of a driving piston caused by the fluid supplied from the pair of hydraulic pumps.

According to the present invention, desirably, the power driving part includes: a casing having a given size; a pair of pistons reciprocated in the interior of the casing by means of the hydraulic pumps; the driving piston reciprocated by a given distance by means of the reciprocation of the pair of pistons; a pair of connecting rods rotating reciprocatedly by means of the driving piston; and rotational load bodies rotating by means of the rotation of the pair of connecting rods.

According to the present invention, desirably, the pair of pistons includes: a first piston located on one side of the casing in such a manner as to be reciprocated by a given distance by means of the driving of one side hydraulic pump; and a second piston located on the other side of the casing in such a manner as to be reciprocated by a given distance by means of the driving of the other side hydraulic pump.

According to the present invention, desirably, the pair of connecting rods includes: a first connecting rod and a second connecting rod disposed in the opposite directions to each other, and the power driving part further includes crankshafts rotating by means of the first connecting rod and the second connecting rod.

According to the present invention, desirably, the driving part includes: a transmission adapted to change the number of rotations thereof; and a hydraulic motor adapted to drive the pair of hydraulic pumps.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view showing a configuration of a hydraulic engine with hydraulic pumps according to a first embodiment of the present invention; and

FIG. 2 is a schematic view showing a configuration of a hydraulic engine with hydraulic pumps according to a second embodiment of the present invention.

### DETAILED DESCRIPTION OF THE PREFERRED EMBODIMENTS

Hereinafter, an explanation on a hydraulic engine with hydraulic pumps according to the present invention will be in detail given with reference to the attached drawings.

A hydraulic engine according to the present invention includes a power supply 10 adapted to supply power to a driving part 20 and to charge the power generated from rotational load bodies 49 through the driving of a power driving part 40, the driving part 20 driven through the power supplied from the power supply 10, a pair of hydraulic pumps 30 adapted to pump a fluid through the rotation of the driving part 20, and the power driving part 40 adapted to generate a driving force through the reciprocation of a driving piston 45 caused by the fluid supplied from the pair of hydraulic pumps 30.

According to the present invention, the hydraulic engine is configured wherein a pair of first and second pistons 42 and 43 disposed on the power driving part 40 moves in the same direction as each other through the pumping of the pair of hydraulic pumps 30 so that the driving piston 45 disposed in a casing 41 of the power driving part 40 is reciprocated to rotate connecting rods 46 and 47, thereby rotating the rotational load bodies 49.

Moreover, the power driving part 40 obtains the power or electric power source from the rotation of the rotational load bodies 49 caused by the rotational forces of the connecting rods 46 and 47.

### First Embodiment

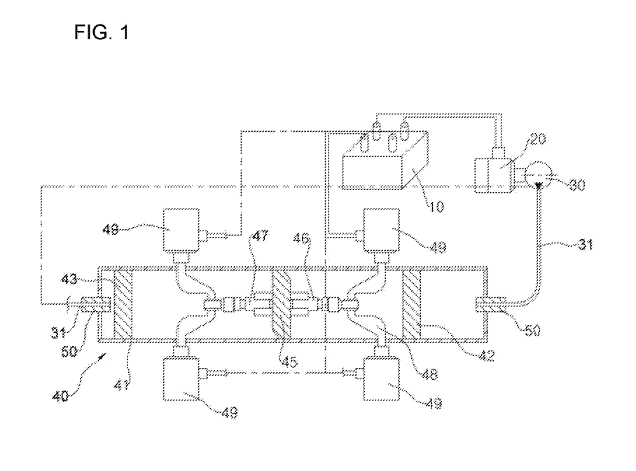

FIG. 1 is a schematic view showing a configuration of a hydraulic engine with hydraulic pumps according to a first embodiment of the present invention.

As shown in FIG. 1, the hydraulic engine with hydraulic pumps according to the present invention includes the driving part 20 rotating by means of the power supply 10.

The power supply 10 includes a battery or charger (not shown) to which the power is charged, and otherwise, the power supply 10 includes a battery adapted to supply power to the driving part 20 and a charger adapted to charge the power generated from the power driving part 40 thereto.

That is, the power supply 10 includes both of the battery for supplying power and the charger for charging power, and otherwise, the power supply 10 includes a single charger for supplying power to the driving part 20 and for charging power thereto.

The driving part 20 makes use of an electric motor rotating by means of the power supplied from the power supply 10.

The driving part 20 is connected to the pair of hydraulic pumps 30, and the hydraulic pumps 30 serve to pump a fluid through the driving of the driving part 20. The hydraulic pumps 30 supply or recover the fluid according to the rotation of the driving part 20.

The hydraulic pumps 30 have connection hoses 31 connected to the first and second pistons 42 and 43 of the power driving part 40. The connection hoses 31 are made of a soft synthetic resin capable of moving gently in accordance with the movements of the first and second pistons 42 and 43.

One pair of hydraulic pumps 30 is disposed to allow the first and second pistons 42 and 43 to move in different directions from each other, and one of the hydraulic pumps 30 is located correspondingly to the first piston 42, while the other is being located correspondingly to the second piston 43.

On the other hand, the hydraulic pumps 30 are configured wherein the first piston 42 and the second piston 43 can move to the opposite directions to each other by means of one pump. If the first piston 42 moves forward, the second piston 43 moves backward, and contrarily, if the second piston 43 moves forward, the first piston 42 moves backward.

The power driving part 40 rotates the rotational load bodies 49 by means of the first and second pistons 42 and 43 moving through the hydraulic pumps 30 and by means of the driving piston 45 reciprocated by the first and second pistons 42 and 43.

The power driving part 40 includes the casing 41 having a given size, the first and second pistons 42 and 43 reciprocated in the interior of the casing 41 by means of the hydraulic pumps 30, the driving piston 45 reciprocated by a given distance by means of the reciprocation of the first and second pistons 42 and 43, the connecting rods 46 and 47 reciprocatedly rotating by means of the driving piston 45, and the rotational load bodies 49 rotating by means of the rotation of the connecting rods 46 and 47.

The casing 41 takes a shape of a cylinder having given length and diameter and has the first piston 42 and the second piston 43 disposed in the interior thereof in such a manner as to be reciprocated by means of the hydraulic pumps 30.

The first piston 42 is located on one side of the casing 41 in such a manner as to be reciprocated by a given distance by means of the driving of one side hydraulic pump 30, and the second piston 43 is located on the other side of the casing 41 in such a manner as to be reciprocated by a given distance by means of the driving of the other side hydraulic pump 30.

The first piston 42 is located on one side of the casing 41 and is connected to one side connection hose 31 in such a manner as to be driven by means of one side hydraulic pump 30. The second piston 43 is located on the other side of the casing 41 and is connected to the other side connection hose 31 in such a manner as to be driven by means of the other side hydraulic pump 30.

The fluid, which moves by means of the first piston 42 and the second piston 43, is filled between the first piston 42 and the second piston 43, and the fluid makes use of general oil as an incompressible fluid.

Further, the driving piston 45 is located between the first piston 42 and the second piston 43. That is, the driving piston 45 is disposed on the intermediate position of the casing 41 in such a manner as to be movable according to the movement of the fluid.

The driving piston 45 has a shape of a disc having a given thickness, and the connecting rods 46 and 47 are disposed on both surfaces of the driving piston 45 to convert the linear motion of the driving piston 45 into rotational motion.

The first connecting rod 46 is disposed on one surface of the driving piston 45, and the second connecting rod 47 on the other surface of the driving piston 45. Further, crankshafts 48 are rotatably mounted on the first connecting rod 46 and the second connecting rod 47.

The crankshafts 48 serve to convert the linear motions of the first connecting rod 46 and the second connecting rod 47 into the rotational motions. The rotational load bodies 49 are disposed on the first connecting rod 46 and the second connecting rod 47.

The rotational load bodies 49 are disposed on both ends of the crankshaft 48 mounted on the first connecting rod 46 and also disposed on both ends of the cranks shaft 48 mounted on the second connecting rod 47, so that the four rotational load bodies 49 are provided.

It should be understood that the rotational load bodies 49 include rotational shafts (not shown) requiring rotational forces or all of parts requiring rotational forces like a generator from which power is generated. That is, the rotational load bodies 49 are generators or rotational shafts.

Further, shock absorbing members 50 are disposed on both ends of the casing 41 to prevent the connection hoses 31 from being damaged or broken and to absorb the shocks caused upon the contacts of the first piston 42 and the second piston 43 with both ends of the casing 41.

### Second Embodiment

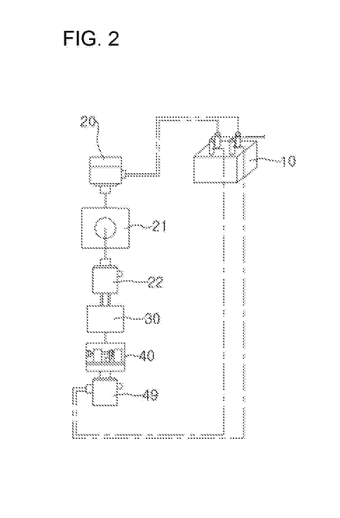

FIG. 2 is a schematic view showing a configuration of a hydraulic engine with hydraulic pumps according to a second embodiment of the present invention.

As shown in FIG. 2, the hydraulic engine according to the second embodiment of the present invention includes the power supply 10, the hydraulic pumps 30 and the power driving part 40 in the same manner as according to the first embodiment of the present invention. Accordingly, an explanation on the same parts will be avoided, and hereinafter, a driving part 20 adopted in the second embodiment of the present invention will be in detail explained.

The driving part 20 is driven by means of the power supplied from the power supply 10 and includes a transmission 21 rotating by means of the driving part 20 and a hydraulic motor 22 rotating by means of the transmission 21.

The transmission 21 rotates by means of the rotational force of the driving part 20 and increase or decreases the number of rotations of the driving part 20. That is, the transmission 21 increases the number of rotations of the motor as the driving part 20, so that the driving part 20 can rotate at a higher speed.

The transmission 21 rotates the hydraulic motor 22, and the hydraulic motor 22 rotates at a high speed by means of the transmission 21 rotating at a high speed so that the hydraulic pumps 22 can pump a fluid at a higher speed.

Next, an explanation on an operating method for the hydraulic engine with the hydraulic pumps according to the present invention will be in detail given.

As shown in FIG. 1, the hydraulic engine according to the first embodiment of the present invention is configured wherein the driving part 20 is driven by means of the power supplied from the battery or charger to which the power is charged. The driving part 20 makes use of the electric motor rotating by means of the power applied thereto.

The driving part 20 drives the hydraulic pumps 30, and the hydraulic pumps 30 serve to pump an incompressible fluid stored through the rotation of the driving part 20.

The fluid pumped by means of the hydraulic pumps 30 is supplied to the first piston 42 through the connection hose 31, and the first piston 42 linearly moves by means of the fluid supplied through the connection hose 31 disposed on one side hydraulic pump 30.

As shown in FIG. 1, the first piston 42 moves in a left direction from a right direction in the drawing, and the second piston 43 and the driving piston 45 move in a left direction of FIG. 1 by means of the fluid filled between the first piston 42 and the second piston 43.

At this time, the second piston 43 located in the opposite direction to the first piston 42 moves in the left direction of FIG. 1.

As the driving piston 45 moves, accordingly, the first connecting rod 46 and the second connecting rod 47 rotate the crankshafts 48.

On the other hand, the second piston 43 moves in the right direction of FIG. 1 by means of the fluid supplied from the other side hydraulic pump 30, and at this time, the first piston 42 moves in the right direction of FIG. 1.

The driving piston 45 moves in the right direction on the drawing together with the first piston 42 and the second piston 43, and as the driving piston 45 moves, accordingly, the first connecting rod 46 and the second connecting rod 47 move to rotate the crankshafts 48.

As the crankshafts 48 rotate, accordingly, the rotational load bodies 49 rotate. That is, the rotational load bodies 49 rotate by means of the crankshafts 48.

The rotational load bodies 49 disposed on the power driving part 40 rotate by the rotation of the connecting rods 46 and 47 and the crankshafts 48 as the driving piston 45 moves according to the movement of the fluid.

The rotational load bodies 49 rotate by means of the fluid supplied from the hydraulic pumps 30, and even if relatively large loads are generated from the rotation of the rotational load bodies 49, the rotational load bodies 49 can rotate with the same number of rotations as each other.

As shown in FIG. 2, the hydraulic engine according to the second embodiment of the present invention is configured wherein the driving part 20 is driven by means of the power supplied from the power supply 10 to rotate the transmission 21. The transmission 21 rotates with the number of rotations higher or lower than the driving part 20.

That is, the transmission 21 rotates with the number of rotations higher than the driving part 20 to allow the hydraulic motor 22 to rotate at a higher speed, and if necessary, the transmission 21 allows the hydraulic motor 22 to rotate at a low speed to obtain a large torque (output).

The hydraulic motor 22 drives the hydraulic pumps 30, and since the operations of the hydraulic pumps 30 are the same as above, a repeated explanation will be avoided.

As set forth in the foregoing, the hydraulic engine according to the present invention is configured wherein the rotational load bodies like the rotational shafts or generators can be at the same time driven on the single power driving part by means of the driving of the hydraulic pumps to obtain a large output, so that large torques can be produced from the rotational shafts or large power can be produced from the generators.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A hydraulic engine comprising:
a power supply (10) adapted to supply power to a driving part (20) and to charge the power generated from rotational load bodies (49) through the driving of a power driving part (40);
the driving part (20) driven through the power supplied from the power supply (10) and having a hydraulic motor (22) adapted to drive a pair of hydraulic pumps (30) and a transmission (21) adapted to change the number of rotations of the hydraulic motor (22) so that the transmission 21 rotates with the number of rotations higher or lower than the driving part (20) to allow the hydraulic motor (22) to rotate at a higher speed or to allow the hydraulic motor (22) to rotate at a lower speed so as to obtain a large torque (output);
the pair of hydraulic pumps (30) adapted to pump a fluid through the rotation of the hydraulic motor (22) of the driving part (20) and having connection hoses (31) connected to the power driving part (40);
the power driving part (40) having a casing (41) having a given size, both ends of the casing (41) being connected to the connection hoses (31) so that the fluid supplied from the pair of hydraulic pumps (30) is supplied to the interior of the casing (41), a first piston (42) located on one side of the casing (41) in such a manner as to be reciprocated by a given distance by means of the driving of one side hydraulic pump (30), a second piston (43) located on the other side of the casing (41) in such a manner as to be reciprocated by a given distance by means of the driving of the other side hydraulic pump (30), a driving piston (45) located on the intermediate position of the casing (41) between the first piston (42) and the second piston (43) in such a manner as to be reciprocated by a given distance by means of the reciprocation of the first piston (42) and the second piston (43), a first connecting rod (46) disposed on one surface of the driving piston (45) in such a manner as to be linearly reciprocated by means of the reciprocation of the driving piston (45), a second connecting rod disposed on the other surface of the driving piston (45) in such a manner as to be linearly reciprocated by means of the reciprocation of the driving piston (45), crankshafts (48) rotatably mounted on the first connecting rod (46) and the second connecting rod (47) in such a manner as to convert the linear motions of the first connecting rod (46) and the second connecting rod (47) into the rotational motions, and the rotational load bodies (49) rotating by means of the rotations of the crankshafts (48) to generate power therefrom; and
shock absorbing members (50) disposed on both ends of the casing (41) to prevent the connection hoses (31) from being damaged or broken and to absorb the shocks caused upon the contacts of the first piston (42) and the second piston (43) with both ends of the casing (41).
